(19) United States
(12) Patent Application Publication
(10) Pub. No.: US 2002/0001048 A1
(43) Pub. Date: Jan. 3, 2002

(54) Method of fabricating liquid crystal display with a high aperture ratio

(76) Inventors: Deuk Su Lee, Kyoungki-do (KR); Jung Mok Jun, Seoul (KR); Seok Lyul Lee, Kyoungki-do (KR)

Correspondence Address: Ladas & Parry, Suite 1200, 224 South Michigan Avenue, Chicago, IL, 60604, US

(21) Appl. No.: 09/893,865

(22) Filed: Jun. 28, 2001

(30) Foreign Application Priority Data
Jun. 29, 2000 (KR) 2000-36531

(51) Int. Cl. G02F 1/136

(52) U.S. Cl. 349/43

(57) ABSTRACT

Disclosed is a method of fabricating a liquid crystal display with a high aperture ratio comprising the steps of: forming a gate bus line including a gate electrode on a transparent insulating substrate and at the same time, forming a storage capacitor electrode in parallel with the gate bus line; depositing a gate insulating layer on the resulting entire surface; forming a semiconductor layer on the gate insulating layer over the gate electrode; forming a data line including source/drain electrodes on the semiconductor layer, thereby completing a thin film transistor; depositing an insulating layer on the resulting lower substrate, wherein the thickness of the insulating layer region formed over the storage capacitor electrode is thinner than that formed over the other part; forming a contact hole by selectively etching the insulating layer in order to expose a predetermined part of the drain electrode; and forming a pixel electrode on the insulating layer to be in contact with the exposed drain electrode.

### BACKGROUND OF THE INVENTION

1. Field of the Invention

The present invention relates to a method of fabricating a liquid crystal display, and more particularly to a method of fabricating liquid crystal display with a high aperture ratio.

2. Description of the Related Art

As well known, it is essential to increase an aperture ratio in order to obtain a liquid crystal display with a high quality screen. Therefore, a method has been proposed in which a pixel electrode area is enlarged. According to this method, a transparent resin insulating layer is interposed between a pixel electrode and data and gate lines to reduce a coupling capacitance and then the pixel electrode is extended to an upper part of the data line, thereby eliminating the separation thereof.

The conventional liquid crystal display will be described in more detail referring to FIGS. 1 and 2.

FIG. 1 is a plane view and FIG. 2 is a cross-sectional view for showing a conventional method of fabricating liquid crystal display with a high aperture ratio.

Referring to FIG. 1, a gate bus line 11 and a data bus line 15 are crossed on a lower substrate 10 to define a unit pixel area in a lattice shape. Here, the data bus line 15 and the gate bus line 11 are insulated by a gate insulating layer (not shown) interposed between them.

When the gate bus line 11 is formed, a storage capacitor electrode 11b is also formed in parallel with the gate bus line 11 and a thin film transistor is formed in the vicinity of the intersection of the lines 11 and 15. The thin film transistor comprises a gate electrode 11a extended from the gate bus line 11 to a unit pixel area at a predetermined distance and the source/drain electrodes 15a and 15b extended from the data bus line 15 at a predetermined distance.

In each unit pixel area, pixel electrodes 17 are disposed, overlapping with sides of the gate bus line 11 and the data bus line 15, thereby obtaining a high aperture ratio. Here, the pixel electrode 17 is in contact with the drain electrode 15b and the contact part thereof is shown as a reference number 19 in FIG. 1.

The method of fabricating a conventional liquid crystal display with a high aperture ratio will be described as follows.

First, a gate electrode 11a and a storage capacitor electrode lib are formed together on a lower substrate 10.

And, a gate insulating layer 12 is deposited on the entire surface of the lower substrate 10 and then, a channel layer 13 is formed to cover the gate insulating layer 12 on a thin film transistor formative region.

Subsequently, a doped amorphous silicon layer 14 for ohmic contact and source/drain metal layers are deposited on the channel layer 13 and then selectively etched to form source/drain electrodes 15a and 15b, thereby obtaining a thin film transistor.

Then, a transparent resin insulating layer 16 is formed on the lower substrate 1 obtained after completion of the thin film transistor in order to reduce coupling capacitance of data bus line and pixel electrode and to eliminate a cause of screen quality degradation. The insulating layer 16 is then selectively etched to expose a predetermined part of the drain electrode 15, thereby forming a contact hole (not shown).

Finally, a pixel electrode 17 is formed on the transparent resin insulating layer 16, being in contact with the exposed drain electrode 15b. As shown in FIG. 2, the pixel electrode 17 is overlapped with predetermined parts of the data bus line 15 and the gate bus line 11.

However, the conventional method of fabricating liquid crystal display with a high aperture ratio has problems as follows.

First, in a conventional method, a transparent resin insulating layer is formed on the lower substrate in order to eliminate a cause of screen quality degradation by reducing coupling capacitance of data bus line and pixel electrode.

The resin insulating layer is formed to have a thickness of several μm in order to prevent screen quality degradation. Due to the thickness, capacitance is reduced and a large electrode is required, thereby decreasing an aperture ratio.

### SUMMARY OF THE INVENTION

Therefore, the present invention has been made to solve the problems of conventional method. The object of the present invention is to provide a liquid crystal display with an improved screen quality and high aperture ratio by reducing a thickness of transparent resin insulating layer using a half-tone exposure.

In order to achieve the above object, the present invention comprises the steps of: forming a gate bus line including a gate electrode on a transparent insulating substrate and at the same time, forming a storage capacitor electrode in parallel with the gate bus line; depositing a gate insulating layer on the resulting entire surface; forming a semiconductor layer on the gate insulating layer over the gate electrode; forming a data line including source/drain electrodes on the semiconductor layer, thereby completing a thin film transistor; depositing an insulating layer on the resulting lower substrate, wherein the thickness of the insulating layer region formed over the storage capacitor electrode is thinner than that formed over the other part; forming a contact hole by selectively etching the insulating layer in order to expose a predetermined part of the drain electrode; and forming a pixel electrode on the insulating layer to be in contact with the exposed drain electrode.

According to the present invention, a liquid crystal display with a high aperture ration is obtained by the following steps of: forming a gate bus line including a gate electrode on a transparent insulating substrate and at the same time, forming a storage capacitor electrode in parallel with the gate bus line; depositing a gate insulating layer on the resulting surface; forming a semiconductor layer on the gate insulating layer over the gate electrode; forming a data line including source/drain electrodes on the semiconductor layer, thereby completing a thin film transistor; depositing a resin insulating layer on the lower substrate, wherein the thickness of the resin insulating layer region formed over the storage capacitor electrode is thinner than that formed over the other part by using a half-tone mask comprising a chrome silicide layer with different transmittance; forming a contact hole by selectively removing the resin insulating layer to expose a predetermined part of the drain electrode; and forming a pixel electrode on the resin insulating layer to be in contact with the exposed drain electrode, wherein the pixel electrode is overlapped with a predetermined part of the data bus line and the gate bus line.

### BRIEF DESCRIPTION OF THE DRAWINGS

FIGS. 1 and 2 are a plane view and a cross-sectional view for showing a conventional method of fabricating a liquid crystal display with a high aperture ratio.

FIG. 3 is a plane view for showing a method of fabricating a liquid crystal display with a high aperture ratio according to the present invention.

FIG. 4 is a cross-sectional view for showing a method of fabricating a liquid crystal display with a high aperture ratio according to the present invention.

FIG. 5 is a cross-sectional view for showing an exposure method of a half-tone mask according to the present invention.

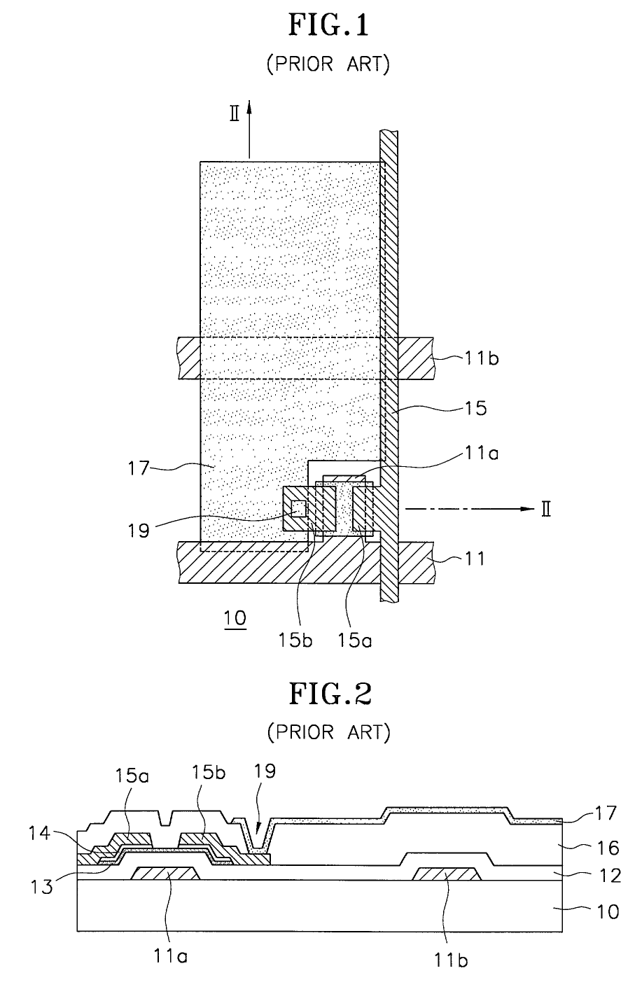

### DETAILED DESCRIPTION OF THE INVENTION

The preferred embodiment of the present invention will be described in detail referring to the drawings.

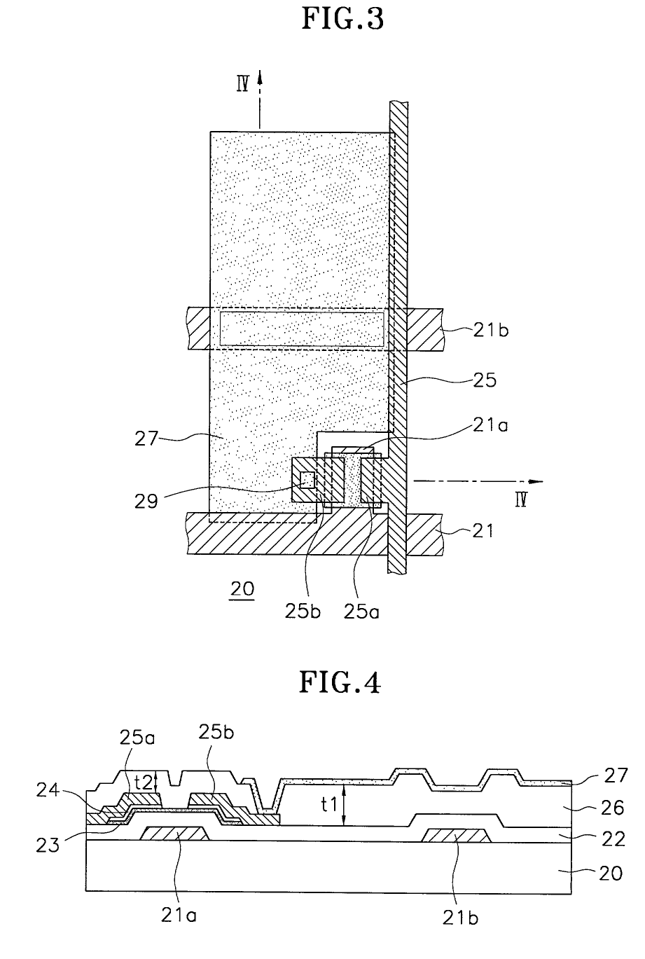

FIG. 3 is a plane view of a liquid crystal display with a high aperture ratio according to the present invention and FIG. 4 is a cross-sectional view taken along IV-IV line of FIG. 3.

Referring to FIG. 3, a gate line 21 and a data line 25 are perpendicularly crossed on a lower substrate 20, thereby defining a unit pixel area in a lattice shape. The data bus line 25 and the gate bus line 21 are insulated by a gate insulating layer (not shown) interposed between them.

And, when the gate bus line 21 is formed, a storage capacitor electrode 21b is also formed in parallel with the gate bus line 21. In the vicinity of the intersection of the gate bus line 21 and the data bus line 25, a thin film transistor is formed, comprising a gate electrode 21a and source/drain electrodes 25a and 25b. Here, the gate electrode 21a is formed to extend from the gate bus line 21 to a unit pixel area, and the source/drain electrodes 25a and 25b are formed to extend from the data bus line 25. Additionally, pixel electrodes 27 are disposed in each unit pixel area, overlapping with sides of the gate bus line 21 and the data bus line 25, thereby increasing an aperture ratio. Also, the pixel electrode 27 is in contact with a drain electrode 25b, and the contact part thereof is shown as a reference number 29 in FIG. 3.

Referring to FIG. 4, a method of liquid crystal display according to the present invention comprises the steps of: forming a gate electrode 21a and a storage capacitor electrode 11a on a lower substrate 20; depositing a gate insulating layer 22 over the entire surface of the lower substrate 20; forming a semiconductor layer comprising a channel layer 23 and doped amorphous silicon layer 24 for ohmic contact to cover the gate insulating layer 22 on a thin film transistor formative region; forming metal layers for source/drain on the semiconductor layer; forming source/drain electrodes 25a and 25b by selectively etching the metal layers and doped amorphous silicon layer 24, thereby completing a thin film transistor; depositing a resin insulating layer 26 on the resulting lower substrate 20; forming a contact hole (not shown) to expose a predetermined part of the drain electrode 25b by selectively etching the resin insulating layer 26; and forming a pixel electrode 27 on the transparent resin insulating layer 26 to be in contact with the exposed drain electrode 25b, overlapping with a predetermined part of the data bus line 25 and the gate bus line 21.

In the above processes, the resin insulating layer 26 is deposited in order to reduce coupling capacitance between the data bus line and the pixel electrode and preferably, using a chrome silicide layer of half-tone mask having different transmittance. Therefore, the resin insulating layer 26 is formed to be thinner on the storage capacitor electrode 21b than on the data line and on the gate line.

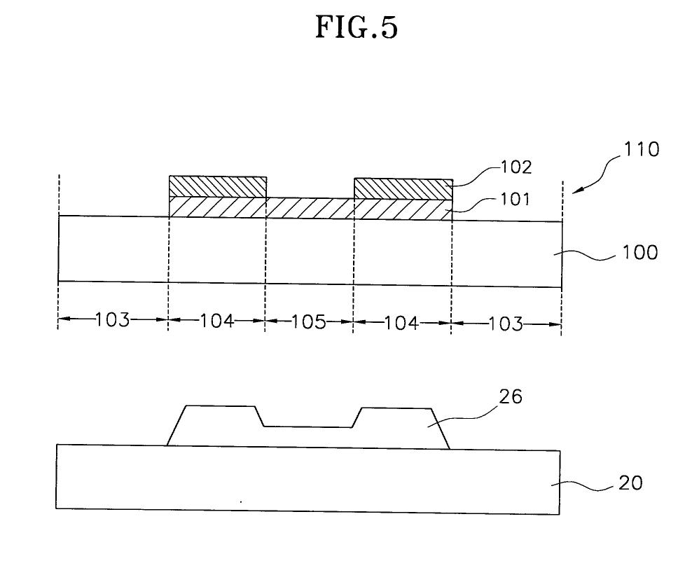

FIG. 5 is a drawing for showing an exposure method of the half-tone mask.

Referring to FIG. 5, a chrome silicide layer 101 is first deposited on a quartz substrate 100 and then a shielding layer 102 is formed on the layer to completely block light, thereby obtaining a half-tone mask 110. The half-tone mask 110 comprises a region 103: transmitting region for completely transmitting light, a region 104 for completely block light by a shielding layer 102 and a region 105: half tone region for transmitting 30 to 70% of light.

The shielding layer 102 preferably comprises chrome. The thickness of the resin insulating layer 26 is formed to be thinner on the half-tone region 105 than on other parts.

Accordingly, as shown in FIG. 4, the thickness of the resin insulating layer 26 over the storage capacitor electrode 21b is deposited to be thinner than that over the data line including the drain electrode or the gate line including the gate electrode. As a result, it is possible to reduce the thickness of the resin insulating layer 26 formed over the storage capacitor formation region to one-third of several μm, and therefore to obtain high capacity in a limited area, thereby increasing an aperture ratio and brightness.

As described above, in a liquid crystal display with a high aperture ratio according to the present invention, a pixel electrode is extended to overlap with sides of a gate line and a data line.

And, a resin insulating layer is employed to reduce coupling capacitance between a data line and a pixel electrode, thereby eliminating a cause of a screen quality degradation.

And, a thickness of resin insulating layer over a storage capacitor is deposited to be thinner than that over a data line and on a gate line.

Therefore, a thickness of the resin insulating layer is reduced to one-third of several μm, thereby improving an aperture ratio and increasing brightness.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed:

1. A method of fabricating a liquid crystal display with a high aperture ratio comprising the steps of:
forming a gate bus line including a gate electrode on a transparent insulating substrate and at the same time, forming a storage capacitor electrode in parallel with the gate bus line;
depositing a gate insulating layer on the resulting entire surface;
forming a semiconductor layer on the gate insulating layer over the gate electrode;
forming a data line including source/drain electrodes on the semiconductor layer, thereby completing a thin film transistor;
depositing an insulating layer on the resulting lower substrate, wherein the thickness of the insulating layer region formed over the storage capacitor electrode is thinner than that formed over the other part;
forming a contact hole by selectively etching the insulating layer in order to expose a predetermined part of the drain electrode; and
forming a pixel electrode on the insulating layer to be in contact with the exposed drain electrode.

2. The method of fabricating a liquid crystal display with a high aperture ratio according to claim 1, wherein a half-tone mask is employed in the step of depositing the insulating layer.

3. The method of fabricating a liquid crystal display with a high aperture ratio according to claim 2, wherein the half-tone mask comprises chrome silicide layer having different transmittance.

4. The method of fabricating a liquid crystal display with a high aperture ratio according to claim 1, wherein the insulating layer comprises a transparent resin.

5. The method of fabricating a liquid crystal display with a high aperture ratio according to claim 1, wherein the insulating layer is one of a transparent material, a semitransparent material and a transparent material at least in a limited predetermined part.

6. The method of fabricating a liquid crystal display with a high aperture ratio according to claim 1, wherein the pixel electrode is formed to overlap with a predetermined part of the data bus line and the gate bus line.

7. The method of fabricating a liquid crystal display with a high aperture ratio comprising the steps of:
forming a gate bus line including a gate electrode on a transparent insulating substrate and at the same time, forming a storage capacitor electrode in parallel with the gate bus line;
depositing a gate insulating layer on the resulting surface;
forming a semiconductor layer on the gate insulating layer over the gate electrode;
forming a data line including source/drain electrodes on the semiconductor layer, thereby completing a thin film transistor;
depositing a resin insulating layer on the lower substrate, wherein the thickness of the resin insulating layer region formed over the storage capacitor electrode is thinner than that formed over the other part by using a half-tone mask comprising a chrome silicide layer with different transmittance;
forming a contact hole by selectively removing the resin insulating layer to expose a predetermined part of the drain electrode; and
forming a pixel electrode on the resin insulating layer to be in contact with the exposed drain electrode, wherein the pixel electrode is overlapped with a predetermined part of the data bus line and the gate bus line.

8. The method of fabricating a liquid crystal display with a high aperture ratio according to claim 7, wherein the insulating layer is one of a transparent material, a semitransparent material and a transparent material at least in a predetermined part.
